(19) United States
(12) Patent Application Publication
(10) Pub. No.: US 2021/0037868 A1
(43) Pub. Date: Feb. 11, 2021

(54) OIL-IN WATER- EMULSIFIED FOOD COMPOSITION WITH MULBERRY EXTRACT

(71) Applicant: Conopco Inc., d/b/a UNILEVER, Englewood Cliffs, NJ (US)

(72) Inventors: Alessia Ermacora, Vlaardingen (NL); Sabrina Silva Paes, Vlaardingen (NL); Petra Verhoef, Vlaardingen (NL)

(73) Assignee: Conopco Inc., d/b/a UNILEVER, Englewood Cliffs, NJ (US)

(21) Appl. No.: 16/964,199

(22) PCT Filed: Jan. 22, 2019
(86) PCT No.: PCT/EP2019/051443

§ 371 Date: Jul. 23, 2020

(30) Foreign Application Priority Data
Feb. 9, 2018 (EP) 18155930.3

(51) Int. Cl. A23L 33/105; A23D 7/005; A23L 27/60; A23L 29/10

(52) U.S. Cl. CPC A23L 33/105; A23D 7/0056; A23V 2002/00; A23L 29/10; A23L 27/60

(57) ABSTRACT

The present invention relates to an oil-in-water-emulsified food product comprising:
Vegetable oil,
Water,
0.01 to 1.5 wt % of extract of Morus alba,
acid,
wherein the extract of Morus alba comprises more than 0.6 wt %, based on the dry weight of the extract, of total polyphenols.

The present invention relates to an oil-in-water emulsified food composition, comprising mulberry extract. It further relates to a method to prepare said food composition and to the use of mulberry extract to provide reduced oxidation in an oil-in-water emulsified food composition.

### BACKGROUND OF THE INVENTION

Dressing compositions, such as mayonnaise, comprise oil which is prone to oxidation when in contact with oxygen, resulting in an off taste and off color to the dressing composition. To counter such undesired oxidation effects, ethylenediaminetetraacetic acid (EDTA) is commonly used, to chelate transition metal ions, which are known to enhance the oxidation process.

There is a trend to produce food products as natural as possible, wherein added chemicals are avoided or reduced where possible. Despite its superb oxidation inhibitory effect, the use of EDTA is not always favored. A need remains for satisfying alternatives for EDTA which are derived from natural sources, which can at least partly replace EDTA. Although some results have been achieved in this area, such alternatives have their own drawbacks, depending on the food product wherein they are used. Such compositions may come with sensorial disadvantages. The color, taste, and texture of the resulting food product may not sufficiently resemble the food product without the anti-oxidative agent.

WO2017/001154 discloses an antioxidant system free of EDTA without undesired color and considered natural. The system is based on caramel and phenolic compounds.

Lee et al., Korean J. Food Nutr. Vol. 27. No. 6, 1132˜1140 (2014) analyses the oxidative stability of mayonnaise prepared with perilla oil, to which mulberry extract was added. The pH of the perilla mayonnaises was 5.54-5.86. This study shows that antioxidant scores increase with mulberry extract levels of 1, 2, 3, 4, and 5%, wherein the highest appearance and sensorial acceptability was reached at 4% and the lowest at 1%.

KR 2011 0119982 discloses a composition including mulberry powder and a production method thereof. The method comprises adding 15-20 part of mayonnaise by weight, and stirring the mixture for 2-5 minutes; adding 0.1-1.5 parts of mulberry powder by weight into the mixture and stirring the mixture for 2-5 minutes; and adding 7-13 parts of lemon juice by weight into the mixture, and stirring the mixture for 1-3 minutes.

Journal of functional foods 18 (2015) 1039-1046 discloses a study on (poly)phenolic compounds and antioxidant activity of white (Morus alba) and black (Morus nigra) mulberry leaves: Their potential for new products rich in phytochemicals.

Food chemistry 64 (1999) 555-559 discloses a study on the determination of flavonoid contents in mulberry and their scavenging effect on superoxide radicals.

Khan et al. BMC research notes 2013, 6:24 discloses a comparative study on the antioxidant activity of methanolic extracts from different parts of Morus alba L. (Moraceae).

It is well known in the art of industrial food production, that the sensorial acceptability highly depends on the interaction of the total of ingredients in the compositions and the type of ingredients used. In this context, it was noticed, that the composition of commercial oil-in-water emulsions, like mayonnaises, comprise a specific blend of oil and (organic) acids and pH level, attributing a specific organoleptic profile to the consumer, including flavour and texture, having its specific oxidation dynamics, in addition to its sensitivity for off-colour.

### SUMMARY OF THE INVENTION

The problem therefore remains to provide an oil-in-water-emulsified food composition, such as a mayonnaise composition, comprising vegetable oil, wherein the sensitivity for oil oxidation is reduced and the organoleptic qualities including texture, color and taste are preferably resembling that of corresponding freshly prepared food products to a commercially acceptable level. Such a food composition contains preferably a reduced level of EDTA or is preferably free of EDTA.

Surprisingly, this problem was solved, at least partly, with an oil-in-water emulsified food composition comprising:
Vegetable oil,
Water,
Extract of Morus alba in an amount of 0.01 to 1.5 wt %, expressed as dry weight of extract on weight of total food composition,
Acid,

wherein the extract of Morus alba comprises polyphenols in a total amount of from 0.6 to 15 GAE, %, preferably of 1 to 15 GAE %, based on the dry weight of the extract.

In another aspect, the invention relates to a method to manufacture a food composition, the method comprising the steps of
a) adding water into a stirred vessel,
b) adding the oil to the water while stirring to create a mixture;
c) combining acid and from 0.01 to 1.5 wt % (expressed as dry weight of the extract based on weight of final resulting composition) of extract of Morus alba with the water in step a), or with the mixture during step b), wherein the extract of Morus alba comprises polyphenols in a total amount of from 0.6 to 15 GAE, %, preferably of 1 to 15 GAE %, based on the dry weight of the extract.
d) homogenising the mixture resulting from step b),

to create an oil-in-water emulsion.

In a further aspect, the invention relates to the use of an extract of Morus alba in an amount of from 0.01 to 1.5 wt % in oil-in-water emulsions comprising vegetable oil, water and acid, to reduce oxidation, wherein the Morus alba extract comprises total polyphenols in a total amount of from 0.6 to 15 wt %, preferably from 2 to 4 wt %, based on the dry weight of the extract.

### DETAILED DESCRIPTION

All percentages, unless otherwise stated, refer to the percentage by weight (wt %).

“Weight ratio” means that the concentration of a first (class of) compound(s) is divided by the concentration of a second (class of) compound(s), and multiplied by 100 in order to arrive at a percentage.

“Spoonable” means that a composition is semi-solid but not free-flowing on a time scale typical for eating a meal, meaning not free-flowing within a time period of an hour. A sample of such substance is able to be dipped with a spoon from a container containing the composition. Except in the operating and comparative examples, or where otherwise explicitly indicated, all numbers in this description indicating amounts or ratios of material or conditions of reaction, physical properties of materials and/or use are to be understood as modified by the word “about”.

Features described in the context of one aspect of the invention can be applied in another aspect of the invention.

The invention provides a food product as defined in the first aspect above.

Emulsion

The composition of the invention is in the form of an oil-in-water emulsion. Examples of oil-in-water emulsions encompassed by the present invention include emulsified sauces, such as mayonnaise, and dressings, such as salad dressings and vinaigrettes. Preferably, the food composition is an emulsified sauce or dressing, preferably a mayonnaise, a salad dressing or a vinaigrette, and most preferably is a mayonnaise. Generally, a mayonnaise is spoonable, while a salad dressing or a vinaigrette is pourable. A vinaigrette traditionally is a mixture of vegetable oil and a vinegar, and may be a stable oil-in-water emulsion.

In the context of the present invention, the preferred oil-in-water emulsion may be stable as an emulsion during a time period of for example less than one hour (like for example some vinaigrettes). It is preferred that (after emulsifying) the emulsion is stable for more than one hour, preferably during a time period of half a year or more (like for example some mayonnaises).

Mayonnaise is generally known as a thick, creamy sauce that can be used as a condiment with other foods. Mayonnaise is a stable water-continuous emulsion of typically vegetable oil, egg yolk and either vinegar or lemon juice. In many countries the term mayonnaise may only be used in case the emulsion conforms to the “standard of identity”, which defines the composition of a mayonnaise. For example, the standard of identity may define a minimum oil level, and a minimum egg yolk amount. Also, mayonnaise-like products having oil levels lower than defined in a standard of identity or not containing egg yolk can be considered to be mayonnaises in the context of the present invention. This kind of products may contain thickeners like starch to stabilise the aqueous phase. Mayonnaises may vary in colour, and are generally white, cream-coloured, or pale yellow. The texture may range from light creamy to thick. Generally, mayonnaise is spoonable. In the context of the present invention “mayonnaise” includes such mayonnaise and ‘mayonnaise-like’ emulsions with vegetable oil levels ranging from 5% to 85% by weight of the product. Mayonnaises in the context of the present invention do not necessarily need to conform to a standard of identity in any country.

Oil

The term “oil” as used herein refers to lipids selected from triglycerides, diglycerides, monoglycerides and combinations thereof. Preferably the oil in the context of this invention, the vegetable oil, comprises at least 90 wt % of triglycerides, more preferably at least 95 wt %. Preferably the oil contains less than 20 wt % of solid oil at 5° C., preferably less than 10 wt % solid oil. More preferred the oil is free from solid oil at 5° C. Most preferred the oil is liquid at 5° C. Preferred oils for use in the context of this invention are vegetable oils which are liquid at 5° C. Preferably the oil comprises sunflower oil, rapeseed oil, olive oil, soybean oil, and combinations of these oils. Therefore, preferably the vegetable oil is an edible oil. The oil preferably comprises mono unsaturated and/or poly unsaturated fatty acids. The mono-unsaturated fatty acids as comprised in the oil preferably comprise oleic acid. The poly-unsaturated fatty acids as comprised in the oil preferably comprise linoleic acid and linolenic acid. Preferably the amount of extra virgin olive oil in the composition of the invention is maximally 40% by weight of the composition. More preferably the amount of extra virgin olive oil in the composition of the invention is maximally 20% by weight of the composition, more preferred maximally 15% by weight of the composition. Preferably the amount of olive oil in the composition of the invention is maximally 20% by weight of the composition, more preferred maximally 15% by weight of the composition more preferred maximally 10% by weight of the composition.

Preferably the concentration of vegetable oil ranges from 5 to 85 wt %, preferably from 10% to 80% by weight, more preferably of from 10 to 78 wt %, even more preferably of from 20 to 70 wt %, based on the weight of the composition. Preferably the amount of vegetable oil is at least 5 wt %, more preferably at least 20% by weight, preferably at least 25% by weight. Preferably the concentration of vegetable oil is maximally 80 wt %, more preferably at most 78 wt % even more preferably at most 70% by weight, preferably maximally 65% by weight, preferably maximally 45%. Any combination of ranges using these mentioned end points are considered to be part of the invention as well.

Water

The composition of the invention comprises water. The total amount of water is preferably of from 15 to 95 wt %, preferably of from 17 to 90 wt %. It can be preferred that water is present in an amount of from 20 to 85 wt %, preferably in an amount of from 22 to 80 wt %. Preferably the amount of water is at least 15 wt %, more preferably at least 17% by weight, even more preferably at least 20%, more preferably at least 22 wt %, even more preferably at least 40 wt % or even 55 wt % by weight. Preferably the concentration of water is maximally 95 wt %, more preferably at most 90 wt %, even more preferably at most 85 wt % more preferably at most 80 wt % even more preferably at most more 75 wt %. Any combination of ranges using these mentioned end points are considered to be part of the invention as well.

Emulsifier

Preferably the composition of the invention comprises an oil-in-water emulsifier. The emulsifier serves to disperse oil droplets in the continuous aqueous phase of an oil-in-water emulsion. Preferably the emulsifier comprises an oil-in-water emulsifier originating from egg, preferably from egg yolk. Preferably the composition comprises egg yolk. This suitably serves as an ingredient which also provides the oil-in-water emulsifier. The presence of egg yolk may be beneficial for taste, emulsification and/or stability of the oil droplets in the composition of the invention. Egg yolk contains phospholipids, which act as emulsifier for the oil droplets. Preferably the concentration of egg yolk in the composition of the invention ranges from 1% to 10% by weight of the composition, more preferred from 2% to 8% by weight of the composition, even more preferably from 2.5% to 6% by weight of the composition. The egg yolk may be added as egg yolk component, meaning largely without egg white. Alternatively, the composition may also contain whole egg, containing both egg white and egg yolk. The total amount of egg yolk in the composition of the invention includes egg yolk that may be present as part of whole egg. Preferably the concentration of phospholipids originating from egg yolk ranges from 0.08% to 0.8% by weight, preferably from 0.2% to 0.5% by weight of the food product.

Alternatively, or in addition to the egg-derived emulsifier, the composition of the invention may comprise an oil-in-water emulsifier that does not originate from egg or egg yolk. Preferably such oil-in-water emulsifier is from plant or botanical origin, and may be used native or modified. This way a vegan oil-in-water emulsifier can be created without ingredients from animal origin. Preferably the oil-in-water emulsifier comprises starch sodium octenyl succinate (European food additive E1450). This emulsifier is available commercially as for example N-creamer 46, ex Ingredion Inc. (Westchester, Ill., USA). Another preferred emulsifier from botanical origin is legume protein.

Acid and pH

The composition of the invention preferably has a pH ranging from 2.5 to 5, preferably ranging from 2.5 to 4.

The total amount of acid in the composition can be determined by titration with sodium hydroxide (NaOH), and expressed as titratable acidity. This is called the titratable acidity, expressed as acetic acid (HAc), which is determined using the following formula.

HAc %=100%·(V·t·M)/m (1)

wherein:

V: volume NaOH solution added (mL)

t: concentration NaOH solution (mol/L)

M: molecular weight HAc (60.052 g/mol)

m: mass (g) product which has been titrated

Preferably the acid comprises organic acid. More preferably, the acid is organic acid. Preferably, the organic acid comprises an acid selected from the group consisting of acetic acid, citric acid, malic acid, lactic acid, succinic acid, formic acid, propionic acid, ascorbic acid, salts thereof and mixtures thereof. Preferably the acid is selected from the group consisting of acetic acid, citric acid, malic acid, lactic acid, succinic acid, salts thereof and mixtures thereof. It is more preferred that the composition comprises acetic acid and salts thereof. Preferably the composition of the invention has a total titratable acidity ranging from 0.03% to 3% by weight expressed as acetic acid, preferably from 0.05% to 2% by weight, preferably from 0.1% to 1% by weight. Acetic acid is preferably present in an amount of more than 50 wt %, more preferably more than 80 wt %, even more preferably more than 90 wt %, even more preferably more than 95 wt % based on the weight of the total amount of acid in the composition.

Preferably, the composition comprises one or more organic acids other than acetic acid, such as preferably selected from the group consisting of citric acid, malic acid, lactic acid, succinic acid, propionic acid, ascorbic acid, salts and mixtures thereof, at a total concentration (all organic acids not being acetic acid taken together) ranging from 0.002% to 0.12% by weight of the composition. Such acids could preferably originate from or be added via vinegar.

Preferably the composition comprises one or more organic acids other than acetic acid at a concentration of such an acid ranging from 0.01% to 0.09% by weight of the composition, more preferred from 0.02% to 0.085% by weight, more preferred from 0.03% to 0.08% by weight, and most preferred from 0.04% to 0.08% by weight.

It can be preferred that the composition comprises acetic acid and one or more acids selected from the group consisting of citric acid, malic acid, lactic acid, succinic acid and mixtures thereof.

The acids as described in this specification include their corresponding salts which are in equilibrium with the acids (acetates, citrates, malates, lactates, succinates, etc.). In case a concentration of an acid is provided, then this concentration refers to total concentration of the acid and its corresponding salt.

Mulberry Extract

The oil-in-water emulsified food product of the present invention comprises Morus alba extract in an amount of from 0.01 to 1.5%, more preferably comprises from 0.05 to 1%, even more preferably from 0.1 to 0.7%, even more preferably of from 0.2 to 0.5%, expressed as dry weight of the extract based on the weight of the emulsified food composition. In salad dressings, the amount is preferably of from 0.01 to 1.5 wt %. In a mayonnaise, the amount is preferably of from 0.01 to 0.7 wt %. The term ‘Morus alba extract’ as used herein refers to a composition that has been isolated from Morus alba extract fruit, leave or root. Typically, the Morus alba extract does not contain insoluble parts such as seeds or peel. Mulberry extract, and in particular Morus alba extract, is defined as the extract as such. For example, without additional processing aids such as for example maltodextrins or sugars.

Mulberry, Morus, is a genus of flowering plants in the family Moraceae, and comprises ten to sixteen species of deciduous trees commonly known as mulberries, growing wild and under cultivation in many temperate world regions. The following species are accepted by the Kew Plant List as of August 2015: Morus alba L., Morus australis Poir., Morus cathayana Hemsl., Morus celtidifolia Kunth, Morus indica L., Morus insignis, Morus japonica Audib., Morus liboensis S.S. Chang, Morus macroura Miq., Morus mesozygia Stapf, Morus mongolica (Bureau) C.K. Schneid., Morus nigra L., Morus notabilis C.K. Schneid., Morus rubra L., Morus serrata Roxb., Morus trilobata (S.S. Chang), Morus wittiorum Hand. Mazz.

KR20110072769 describes a mulberry sauce containing mulberry fruit extract. In the present invention the mulberry extract is obtained from the fruit, leaves or root, preferably of the fruit, of the species Morus alba. Most preferably, the mulberry extract is obtained from the white fruit of the Morus alba.

The mulberry extract in the emulsified food composition of the invention (the Morus alba extract) is preferably selected from extract of fruit, leaves, root and combinations thereof, preferably the Morus alba extract is Morus alba fruit extract. Morus alba extract is preferably applied in dried form, more preferably in dried, ground form. The Morus alba extract that is employed in accordance with the present invention can be a solid product, a paste or a liquid. Preferably, the Morus alba extract is a dry solid product, preferably a powder.

In the present invention, the preferred Morus alba extract extract is a Morus alba fruit extract. It may be preferred that the extract is an aqueous Morus alba fruit extract, more preferably the extract is a dried extract obtained from an aqueous Morus alba fruit extract.

Preferably at least 80 wt. % of the dry matter of the Morus alba extract, preferably obtained from an aqueous Morus alba extract, preferably of a Morus alba fruit extract, dissolves when the material is added to demineralized water at a temperature of 20° C. in a concentration providing 20 gram of dry matter per litre. The Morus alba extract is preferably a dried aqueous extract of mulberry fruit.

Preferably, the Morus alba extract has a water content of less than 15 wt. %, more preferably of less than 10 wt. % and most preferably of less than 8 wt. %.

A dried mulberry extract, preferably a mulberry fruit extract, obtained from an aqueous mulberry extract, or mulberry fruit extract respectively, which can be used in accordance with the present invention, may suitably be obtained as follows: dried mulberry fruit, root or leave, preferably fruit, is sliced, extracted with water, filtered and concentrated, and finally dried (e.g. by spray-drying) into fine powder. No excipient needs to be used during such spray-drying process, resulting in a final product with a dried mulberry material to dried extract ratio of e.g. 10:1.

The mulberry extract that is employed in accordance with the present invention preferably has the following dry matter composition:
10-40 wt. % amino acids (including amino acid residues contained in peptides and proteins);
7-28 wt. % organic compounds with an acidic function other than amino acids;
11-44 wt. % carbohydrates.

To this end, the composition of the invention preferably contains DNA and/or RNA of Morus alba.

In the composition of the invention the mulberry extract is preferably dissolved in the water. According to the invention, it was found that the total amount of polyphenols in the mulberry extract is more than 0.6 GAE % (“gallic acid equivalents”), more preferably 1 GAE %, based on the dry weight of the mulberry extract. Preferably, from 0.6 GAE % to 15 GAE %, more preferably from 1 to 15 GAE %, more preferably from 0.6 to 10 GAE %, even more preferably of from 0.6 to 6 GAE %, more preferably from 1.5 to 6 GAE %, even more preferably of from 2 to 4 GAE %. A common method to determine the phenolic compounds concentration of a sample, is the concentration in “gallic acid equivalents” (GAE). Whenever reference is made herein to “gallic acid equivalents” what is meant is the amount of gallic acid equivalents as determined by the Folin-Ciocalteu assay, as known in the art. Gallic acid (3,4,5-trihydroxybenzoic acid) is the phenolic acid that is used as a standard for determining the phenol content of various analyses by the Folin-Ciocalteu assay (see V. L. Singleton et al., Analysis of total phenols and other oxidation substrates and antioxidants by means of Folin-Ciocalteu reagent, Methods in Enzymology 299, 152-178, 1999).

The mulberry extract as used in the composition of the invention preferably comprises total free amino acids in an amount of more than 3 mg/g, based on the dry weight of the extract. Preferably from 3 to 150 mg/g, even more preferably of from 50 to 120 mg/g, even more preferably of from 70 to 100 mg/g, even more preferably of from 80 to 100 mg/g, based on the dry weight of the extract.

The mulberry extract as used in the composition of the invention preferably comprises organic acids in a total amount of from 17 to 200 mg/g, preferably of from 40 to 200 mg/g, preferably from 80 to 180, even more preferably of from 120 to 160 mg/g based on the dry weight of the extract. Organic acid is understood here as acetic acid, citric acid, malic acid, lactic acid, succinic acid, formic acid, propionic acid, ascorbic acid, salts thereof, and mixtures thereof. It is particularly preferred, when the extract of Morus alba comprises organic acids in a total amount of from 17 to 200 mg/g, preferably of from 40 to 200 mg/g, preferably from 80 to 180, even more preferably of from 120 to 160 mg/g based on the dry weight of the extract and from 0.6 to 15 GAE %, more preferably from 1 to 15 GAE %, even more preferably from 0.6 to 10 GAE %, even more preferably of from 0.6 to 6 GAE %, more preferably of from 1.5 to 6 GAE %, even more preferably of from 2 to 4 GAE %, based on the dry weight of the Morus alba extract.

The mulberry extract as used in the composition of the invention preferably comprises citric acid and salts thereof in an amount of more than 20 wt %, based on the weight of total organic acids in the extract. A most preferred amount is from 65 to 85 wt % based on the weight of total organic acids in the extract. Organic acid is understood here as acetic acid, citric acid, malic acid, lactic acid, succinic acid, formic acid, propionic acid, ascorbic acid, salts thereof and mixtures thereof.

The mulberry extract as used in the composition of the invention preferably comprises from 1 to 100, preferably from 40 to 60 mg/g of quinic acid and salts thereof, based on the dry weight of the Morus alba extract.

Amounts of total amino acids, organic acids, citric and quinic acid can for example be determined by NMR analysis, as known in the art, and specified in the example section herein.

Color variations are not appreciated by some consumers. It is a preference, and a preferred advantage of the invention, that the food composition has a color that is not too different from the color of the product without mulberry extract. Color can be measured as known in the art according to a CIE L*a*b* scale. In particular, compositions are preferred having a L*a*b* color value of the Morus alba extract, measured at 0.1% of the extract in water, wherein the L* value of a 0.1% w/w aqueous solution of the extract is higher than 80, preferably from 80 to 92, more preferably is from 88 to 90. The b* value is preferably more than 1, preferably of between 1 and 30, even more preferably of between 2 and 20, most preferably of between 4 and 12. Such L* values and b* values, preferably the combination of such L* and b* values of the extract provide food compositions according to the invention, especially mayonnaise compositions, which most resemble, with respect to color, the food compositions without the Morus alba extract.

L* for mayonnaise compositions according to the invention is preferably of from 50 to 95, preferably of from 70 to 95, even more preferably of from 80 to 92, most preferably of from 85 to 92. The difference in color ΔE between the colour of a composition with and without the Morus alba extract is calculated as follows ΔE*=SQRT(ΔL*²+Δa*²+Δb*²). The difference in color ΔE is preferably of from 0 to 30, more preferably of from 0 to 20, even more preferably of from 0 to 10 and most preferably of from 0 to 5. These maximum differences in color ΔE are especially desired and preferred if the product is a mayonnaise or a salad dressing, but are not limited to these types of food product.

Hence, preferably the Morus alba extract comprises
total polyphenols in an amount of from 0.6 to 15 GAE %, preferably of from 1 to 15 GAE %, even more preferably of from 1 to 10 GAE %, even more preferably of from 1.5 to 6 GAE %, most preferably of from 2 to 4 GAE %, based on the dry weight of the Morus alba extract
total free amino acids in an amount of from 3 to 150 mg/g, even more preferably of from 50 to 120 mg/g, even more preferably of from 70 to 100 mg/g, even more preferably of from 80 to 100 mg/g, based on the dry weight of the Morus alba extract.
total organic acids in an amount of from 17 to 200 mg/g, preferably of from 40 to 200 mg/g, preferably of from 80 to 180 mg/g more preferably of from 120 to 160 mg/g, based on the dry weight of the Morus alba extract, wherein organic acid is understood here as acetic acid, citric acid, malic acid, lactic acid, succinic acid, formic acid propionic acid, ascorbic acid, salts thereof and mixtures thereof, and
wherein the Morus alba extract has an L*a*b* value when measured in a 0.1% w/w aqueous solution wherein the L* value is higher than 80, preferably from 80 to 92, more preferably is from 88 to 90 and the b* value is preferably more than 1, preferably of between 1 and 30, even more preferably of between 4 and 12.
In this extract it is preferred that quinic acid is present in an amount of from 1 to 100, preferably from 40 to 60 mg/g and salts thereof based on the dry weight of the Morus alba extract.

Other Ingredients

The composition of the invention preferably contains additionally other ingredients than already specifically mentioned in here. Preferably the composition contains plant material in the form of herbs and/or spices. In case such ingredients are present in the composition, then generally their total concentration is at least 0.1% by weight, and preferably maximally 10% by weight, preferably maximally 5% by weight.

The composition of the invention may comprise sugar, but high levels are not desired. Sugar may be present to an amount of from 0.1 to 15 wt %, preferably of from 0.3 to 6 wt %, even more preferably of from 0.4 to 5 wt %, most preferably of from 0.5 to 4 wt %, based on the weight of the composition.

Total alkaline metal salt, for example sodium chloride, may be present to an extent of from 0.1 to 5 wt %, preferably from 0.15 to 4 wt %, or more preferably of from 0.2 to 3 wt %, based on the weight of the composition.

The food composition of the invention may comprise a thickener. It may be preferred that the food composition comprises a thickener such as a hydrocolloid thickener. Therefore, the food composition may preferably comprise starch or gum or mixtures thereof. A preferred gum is xanthan gum. The composition may comprise starch in an amount of from 0.1 to 8 wt %, preferably of from 0.2 to 7 wt %, more preferably of from 0.5 to 6 wt %, or even from 0.5 to 5 wt % can be preferred, based on the weight of the food product. It is preferred, that when starch is present, or gum, the oil content is between 5 and 72 wt %, preferably of between 8 and 70 wt %, preferably of between 10 and 50 wt % based on the weight of the food product.

A great advantage of the composition of the invention is that the oxidation of the vegetable oil is strongly reduced as compared to compositions without mulberry extract as defined herein. Therefore, the amount of EDTA which commonly is present in compositions containing vegetable oil can be strongly reduced. In this way a food composition is presented to the consumer, which does not contain compounds which are often regarded to be ‘chemical’ or ‘artificial’ by that consumer. Hence, preferably the composition comprises EDTA at a concentration lower than 0.008 wt %, preferably from 0 to 0.007% by weight, preferably lower than 0.005% by weight, preferably from 0 to 0.005 wt %, preferably lower than 0.002% by weight, preferably from 0 to 0.002 wt % preferably lower than 0.001% by weight, preferably from 0 to 0.001 wt % of the composition. Most preferred EDTA is absent from the composition.

Method for Preparation of Composition

The compositions of the invention are prepared by any method commonly known for preparing oil-in-water emulsions. Preferably, by using such method, an oil-in-water emulsion is prepared, wherein the oil droplets have a surface weighted mean diameter D3,3 of less than 10 micrometer (see M. Alderliesten, Particle & Particle Systems Characterization 8 (1991) 237-241; for definitions of average diameters).

Accordingly, in a second aspect the present invention provides a method for making an emulsified food composition according to the first aspect of the invention. Preferred compounds and amounts indicated in the first aspect of the invention apply for this aspect as well. The method comprises the steps of:

a) adding water into a stirred vessel,

b) adding oil to the water while stirring to create a mixture;

c) combining acid and 0.01 to 1.5 wt % (expressed as dry weight of the extract based on weight of final resulting composition) of extract of Morus alba with the water during step a), or with the mixture during step b), wherein the extract of Morus alba comprises polyphenols in a total amount of from 1 to 15 GAE, %, preferably from 2 to 4 GAE, %, based on the dry weight of the extract.

d) homogenising the mixture resulting from step b) to create an oil-in-water emulsion.

The method of the invention comprising homogenisation of a mixture of oil and water. This results in an oil-in-water emulsion. Technology to prepare oil-in-water emulsions is known in the art, e.g. for mayonnaise making. Preferably, water and water soluble ingredients are provided in step a). The acid can be pre-added to the water in step a). Also, the mulberry extract can be added to the water in step a). This water phase is combined with oil in step b). Hence, step c) is not meant to be necessarily applied after step b). Acid and mulberry extract can be added together with the oil to the water if so preferred. Acid can be added as such or, preferably, in the form of vinegar. The water in the composition encompasses the water present in the vinegar, as the amount of water refers to the total water content of the resulting composition. Preferably, oil is slowly added to create a coarse emulsion. The mixture of water and oil, comprising acid and mulberry extract, is then homogenised (step d). A colloid mill could be used to achieve this. Preferably an oil-in-water emulsion results from homogenisation. In the emulsion, the oil droplets preferably have a volume weighted mean droplet size D3,3 of less than 10 micrometer. The amount of Morus alba extract is as described for the composition above, and ranges from 0.01 to 1.5 wt %, preferably 0.05 to 1, more preferably of from 0.1 to 0.7 even more preferably of from 0.2 to 0.5 wt % (expressed as dry weight of Morus alba extract, based on weight of final resulting composition).

Extract of Morus alba is preferably added as a powder, more preferably a powder which has a moisture content of less than 15 wt. %, more preferably of less than 10 wt. % and most preferably of less than 8 wt. %. The powder is preferably dried powder, more preferably is freeze dried powder. If the powder is freeze dried, it preferably has a moisture content of less than 5 wt %.

It is preferred, when in step a) or b) an emulsifier is included, especially in case an emulsion is prepared. The emulsifier is preferably as described above in relation to the product description.

In a third aspect, the present invention relates to the use of extract of Morus alba in an amount of from 0.01 to 1.5 wt %, preferably of from 0.05 to 1, more preferably of from 0.1 to 0.5 wt % in an oil-in-water emulsified food composition, preferably a mayonnaise, salad dressing or vinaigrette, the emulsion comprising vegetable oil, water and acid, to reduce oxidation of the food composition, preferably while resembling the color of that emulsified food composition without the mulberry extract. Such extract comprises polyphenols in an amount of from 0.6 to 15 GAE %, preferably from 1 to 15 GAE %, based on the dry weight of the extract. By this invention, EDTA can be reduced or preferably be replaced from oil-in-water emulsified food products such as in particular mayonnaise, salad dressings or vinaigrettes. Preferably the composition wherein the Morus alba extract is used comprises EDTA at a concentration lower than 0.008 wt %, preferably from 0 to 0.007% by weight, preferably lower than 0.005% by weight, preferably from 0 to 0.005 wt %, preferably lower than 0.002% by weight, preferably from 0 to 0.002 wt % preferably lower than 0.001% by weight, preferably from 0 to 0.001 wt % of the composition. Most preferred EDTA is absent from the composition.

Preferably, the color of the oil-in-water emulsion has a color characterized by the L*a*b* values wherein the difference in color ΔE* between the emulsion comprising the Morus alba extract and the emulsion without the extract, calculated as ΔE*=SQRT(ΔL*²+Δa*²+Δb*²), is from 0 to 30.

The invention will now be exemplified by the following, non-limiting examples:

### EXAMPLES

Raw Materials
Water: demineralised water.
Rapeseed oil ex Cargill (Amsterdam, The Netherlands).
Sugar: sucrose white sugar W4 ex Suiker Unie (Oud Gastel, Netherlands).
Salt: NaCl suprasel ex Akzo Nobel (Amersfoort, Netherlands).
EDTA: Ethylenediaminetetraacetic acid, calcium disodium complex, dehydrate; Dissolvine E-CA-10 ex Akzo Nobel (Amersfoort, Netherlands).
Egg yolk: ex Bouwhuis Enthoven (Raalte, the Netherlands); contains 92% egg yolk and 8% kitchen salt.
Vinegar spirit 12% ex Kühne (Hamburg, Germany)
Lemon and Mustard liquid flavour mix
Sorbic acid, E200

Extracts (Dry Powders)

TABLE 1

| | | |
|---|---|---|
| Extract 1 | Mulberry extract Draco A | Mulberry fruit, Morus alba |
| Extract 2 | Xian Lukee Bio-Tech Co., Ltd. (Fruit) | Mulberry fruit, Morus alba |
| Extract 3 | Fengi Biotech Co., Ltd. | Mulberry fruit, Morus alba |
| Extract 4 | Phyto Planet | Mulberry fruit, Morus alba |
| Extract 5 | Baoji Oasier Bio-Tech Co., Ltd. | Mulberry fruit, Morus alba |
| Extract 6 | Xian Lukee Bio-Tech Co., Ltd. (Leaf) | Mulberry leaf, Morus alba |
| Extract 7 | Longze Biotechnology (Blackberry) | Blackberry fruit |
| Extract 8 | Xian Xuochang Trade Co., Ltd | Mulberry fruit, Morus alba |
| Extract 9 | Mulberry extract Draco B | Mulberry fruit, Morus alba |

Dry Weight Can be Calculated by the Following Protocol:

A sample is weighed into an aluminium cup and frozen at −20° C. The cup is then placed into the freeze dry equipment where a vacuum is created using a vacuum pump. The temperature in the machine is then slowly increasing to 10° C. This will cause water to sublimate from the sample, which is then removed from the cabinet. The total time for this process is about 24 hours. The mass loss expressed as % (m/m) is considered to be the moisture content. The mass residue expressed as % (m/m) is considered to be the dry matter content.

### Example 1

Accelerated Shelf-Life Test to Follow Lipid Oxidation in Mayonnaise Compositions

Formulations

TABLE 2

| | EDTA | No EDTA | 0.1% | 0.3% | 0.5% |
|---|---|---|---|---|---|
| | mayo | (NEG | Mulberry | Mulberry | Mulberry |
| | (POS Ref) | Ref) | extract | extract | extract |
| Material name | % w/w | % w/w | % w/w | % w/w | % w/w |
| Water | 15.53 | 15.54 | 15.44 | 15.24 | 15.04 |
| Calcium disodium EDTA | 0.0075 | 0 | 0 | 0 | 0 |
| Refined oil (rapeseed) | 75 | 75 | 75 | 75 | 75 |
| Sugar (sucrose) | 1.3 | 1.3 | 1.3 | 1.3 | 1.3 |
| Salt (sodium chloride) | 1.03 | 1.03 | 1.03 | 1.03 | 1.03 |
| Vinegar spirit 12% | 2.6 | 2.6 | 2.6 | 2.6 | 2.6 |
| Egg yolk | 4.2 | 4.2 | 4.2 | 4.2 | 4.2 |
| Flavours | 0.24 | 0.24 | 0.24 | 0.24 | 0.24 |
| Sorbic acid, E200 | 0.09 | 0.09 | 0.09 | 0.09 | 0.09 |
| Mulberry fruit extract | 0 | 0 | 0.1 | 0.3 | 0.5 |
| (Extract 9) | | | | | |

Methods

Mayonnaise compositions as indicated above are subjected to conditions which promote oxidation, without requiring the typical shelf life of 4 to 9 months of mayonnaise. Oxidation experiments are carried out during a period up to maximally 67 days, to follow the oxidation of the vegetable oil in oil-in-water emulsions.

Emulsion samples with various compositions are prepared (as described in the examples below) and 1 g of each sample is filled in a capped glass vial (20 mL volume) and kept in a temperature controlled oven at 50° C. In normal use, products can be stored at lower temperatures, such as in the fridge.

Oxygen Concentration in Headspace

To follow oxidation of fatty acids in emulsions in the experiments, the oxygen concentration is measured in the headspace of closed jars (capped glass vials) in which emulsions are stored to follow oxidation. The lower this concentration, the more oxygen is consumed for oxidation processes. The oxygen content is determined by taking a sample of gas from the headspace with a needle through a septum in the closed lid of the jar. The oxygen concentration in the sample is determined by gas analyser.

Mulberry fruit extract (Draco, Extract 9) was added to a mayonnaise composition comprising 75% refined rapeseed oil, at concentrations of 0.1, 0.3 and 0.5 wt %, based on the weight of the mayonnaise composition. As a positive control the mayonnaise composition contained 0.0075 wt % EDTA. Also, a composition without mulberry extract was used. The pH of the compositions was 3.7-3.8.

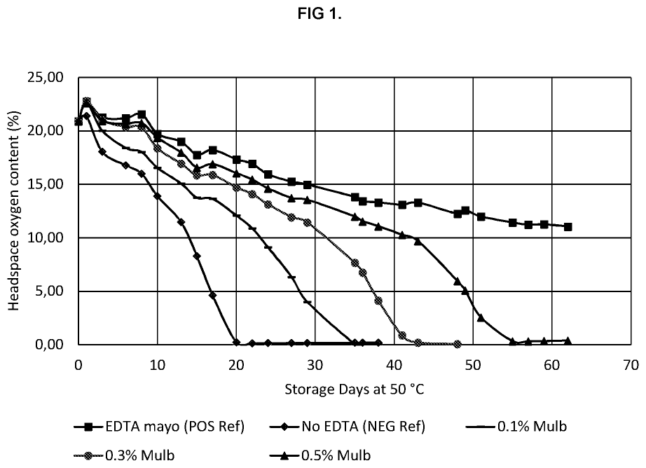

Oxygen consumption in the head space of the jar, indicated as % of present oxygen, is used as the measure for oxidation of the mayonnaise composition. The results are depicted in FIG. 1.

Result

FIG. 1 shows that in the positive control (EDTA, squares), after 62 days 11.2% of the oxygen is left. The negative control (diamonds) showed that all oxygen was consumed after about 20 days, and the amount of 11% oxygen was already reached after 13 days. The compositions with 0.1, 0.3 and 0.5 wt % mulberry extract (dashes, bullets, triangles, respectively) showed that no oxygen was present anymore after 35, 41 and 55 days respectively. Although the compositions with mulberry extract were not as stable as the control composition comprising EDTA, they showed significantly better results than when no mulberry extract was present. These results were achieved with very low concentrations of mulberry extract, indicating the strong oxidation-inhibitory effect. No off-color of the samples was observed compared to the sample without Morus alba extract, as judged by visual assessment.

### Example 2

Taste Analysis of Mayonnaise Compositions Comprising Mulberry Extract After Storage.

Compositions

The same compositions were used as in Example 1.

Method

To assess the development of off taste of mayonnaise compositions comprising mulberry extract, the compositions of Example 1 where stored at ambient temperature and tested by a trained tasting panel (5 people) for 3 months of storage. The samples were scored (1) fresh, (2) just acceptable, or (3) off taste. Scores were averaged, and an average score of 1 is fresh, between 1 and 2 is fresh-acceptable, between 2 and 3 is borderline, 3 is off taste.

Result

All five compositions tasted fresh (1) at T0. After one month, the negative reference (no extract) had developed unacceptable off taste (3). After three months, the positive control (EDTA) was still fresh (1). The samples with mulberry extract scored fresh-acceptable. This test indicates that the samples with low levels of mulberry extract remain sufficiently fresh after 3 months of storage when stored at ambient temperature.

### Example 3

Inhibition of Oxidation for Different Mulberry Extract Compositions.

To assess the differences between various mulberry extracts with regard to their capacity to inhibit oxidation in a mayonnaise composition, seven mulberry extracts were compared, in an amount of 0.25% on the mayonnaise composition. In addition, a blackberry extract (Extract 7, comparative example) was tested and a composition with EDTA (positive control, composition 1), and a composition without EDTA or extract (negative control, composition 2). The mayonnaise compositions were stored at 50° C., and the oxygen consumption from the headspace of the container was monitored as measure for oxidation, according to the method in example 1.

The compositions are indicated in the table 3 below. The pH of the compositions was 3.7.

TABLE 3

| | +contr. | −contr. | Extr. 1 | Extr. 2 | Extr. 3 | Extr. 4 | Extr. 5 | Extr. 6 | Extr. 7 | Extr. 8 |
|---|---|---|---|---|---|---|---|---|---|---|
| formulation | % w/w | % w/w | % w/w | % w/w | % w/w | % w/w | % w/w | % w/w | % w/w | % w/w |
| Water | 15.53 | 15.54 | 15.29 | 15.54 | 15.54 | 15.54 | 15.54 | 15.54 | 15.54 | 1554 |
| Calcium disodium | 0.0075 | 0 | 0 | 0 | 0 | 0 | 0 | 0 | 0 | 0 |
| EDTA | | | | | | | | | | |
| Refined oil | 75 | 75 | 75 | 75 | 75 | 75 | 75 | 75 | 75 | 75 |
| (rapeseed) | | | | | | | | | | |
| Sugar (sucrose) | 1.3 | 1.3 | 1.3 | 1.3 | 1.3 | 1.3 | 1.3 | 1.3 | 1.3 | 1.3 |
| Salt (sodium | 1.03 | 1.03 | 1.03 | 1.03 | 1.03 | 1.03 | 1.03 | 1.03 | 1.03 | 1.03 |
| chloride) | | | | | | | | | | |
| Vinegar spirit | 2.6 | 2.6 | 2.6 | 2.6 | 2.6 | 2.6 | 2.6 | 2.6 | 2.6 | 2.6 |
| 12% | | | | | | | | | | |
| Egg yolk | 4.2 | 4.2 | 4.2 | 4.2 | 4.2 | 4.2 | 4.2 | 4.2 | 4.2 | 4.2 |
| Flavours | 0.24 | 0.24 | 0.24 | 0.24 | 0.24 | 0.24 | 0.24 | 0.24 | 0.24 | 0.24 |
| Sorbic acid, | 0.09 | 0.09 | 0.09 | 0.09 | 0.09 | 0.09 | 0.09 | 0.09 | 0.09 | 0.09 |
| E200 | | | | | | | | | | |
| Extract 1 | 0 | 0 | 0.25 | 0 | 0 | 0 | 0 | 0 | 0 | 0 |
| Extract 2 | 0 | 0 | 0 | 0.25 | 0 | 0 | 0 | 0 | 0 | 0 |
| Extract 3 | 0 | 0 | 0 | 0 | 0.25 | 0 | 0 | 0 | 0 | 0 |
| Extract 4 | 0 | 0 | 0 | 0 | 0 | 0.25 | 0 | 0 | 0 | 0 |
| Extract 5 | 0 | 0 | 0 | 0 | 0 | 0 | 0.25 | 0 | 0 | 0 |
| Extract 6 | 0 | 0 | 0 | 0 | 0 | 0 | 0 | 0.25 | 0 | 0 |
| Extract 7 | 0 | 0 | 0 | 0 | 0 | 0 | 0 | 0 | 0.25 | 0 |
| Extract 8 | 0 | 0 | 0 | 0 | 0 | 0 | 0 | 0 | 0 | 0.25 |
| Result | | | #2 | | #1 | | #4/5 | #3 | | #4/5 |

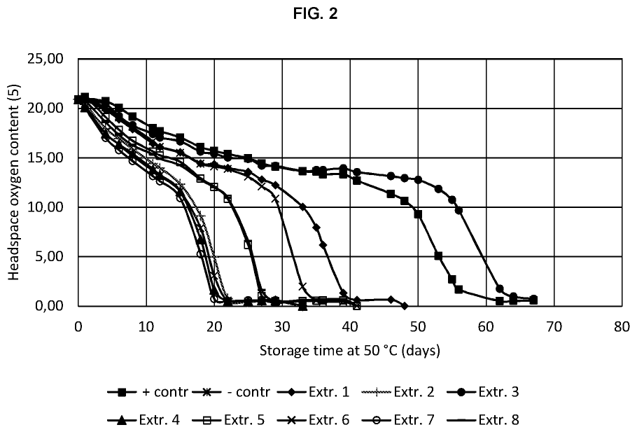

The results have been depicted in FIG. 2.

FIG. 2 shows that extracts differ with regard to oxidation reduction. Extract 3 showed an antioxidative effect which was stronger than that of the positive control.

Extracts 1 and 6 showed a good antioxidative effect. Extracts 5 and 8 showed acceptable results as well. The other compositions showed a result not very different from the negative control.

### Example 4 Chemical Characterisation of the Mulberry Extracts

In order to further assess the chemical differences of the mulberry extracts, the compositions were analyzed for the following parameters:
Total polyphenols,
Total free amino acids
Total organic acids (citric acid, malic acid, lactic acid, succinic acid, formic acid, propionic acid, ascorbic acid and salts thereof),
Citric acid and its salts
Quinic acid and its salts
Color

Methods—Phenolic Compounds

The concentration of phenolic compounds is expressed as “gallic acid equivalents” (GAE), and determined using the Folin-Ciocalteu assay (see V. L. Singleton et al., Analysis of total phenols and other oxidation substrates and antioxidants by means of Folin-Ciocalteu reagent, Methods in Enzymology 299, 152-178, 1999).

Methods—Organic Acids and Free Amino Acids

Quantitative analysis of organic acids and free amino acids in various sources of organic acids was carried out spectroscopically (¹H-NMR).

200 mg of sample (extracts) was weighed and added with 3 ml of D₂O. 600 μl of such sample mixture was added with 100 μl of CSI (Chemical Shift Indicator) solution (consisting of 10.90 mg of 3-(trimethylsilyl)propionic-2,2,3,3-d₄acid, sodium salt, 2.30 mg of difluorotrimethyl-silanyl-methyl)phosphonic acid and 30 ml of D₂O), 100 μl of EDTA-d₁₂ solution, and 300 μl of 0.2 M phosphate buffer. The sample mixture was homogenised and centrifuged at 15000 g for 10 minutes. 650 μl of the supernatant was transferred into 5-mm NMR tubes for analysis.

1D ¹H NMR spectra were recorded with a noesygppr1d pulse sequence on a Bruker Avance III 600 NMR spectrometer, equipped with a 5-mm cryo-probe. The probe was tuned to detect ¹H resonances at 600.25 MHz. The internal probe temperature was set to 298K. 128 scans were collected in 57K data points with a relaxation delay of 10 seconds, an acquisition time of 4 seconds and a mixing time of 100 ms. Low power water suppression (16 Hz) was applied for 0.99 seconds. The data were processed in Topspin software version 3.5 μl 1 (Bruker BioSpin GmbH, Rheinstetten, Germany). An exponential window function was applied to the free induction decay (FID) with a line-broadening factor of 0.15 Hz prior to the Fourier transformation. Manual phase correction and baseline correction was applied to all spectra. The spectra were referenced against the methyl signal of 3-(trimethylsilyl)propionic-2,2,3,3-d₄ acid, sodium salt (δ 0.0 ppm).

Method Citric Acid, Quinic Acid

Same method as for organic acids described above.

Results Polyphenols

The total polyphenol values, expressed as GAE, %, of the tested extracts were:

TABLE 4
(ND = not done)

| | | | Oxidation |
|---|---|---|---|
| Extract name | | GAE, % | reduction |
| Mulberry extract Draco A | Extract 1 | 3.37 | #2 |
| Xian Lukee Bio-Tech Co., Ltd. (Fruit) | Extract 2 | 0.49 | |
| Fengi Biotech Co., Ltd. | Extract 3 | 13.00 | #1 |
| Phyto Planet | Extract 4 | 0.40 | |
| Baoji Oasier Bio-Tech Co., Ltd. | Extract 5 | 0.65 | #4/5 |
| Xian Lukee Bio-Tech Co., Ltd.(Leaf) | Extract 6 | 2.80 | #3 |
| Longze Biotechnology (Blackberry) | Extract 7 | 0.85 | |
| Xian Xuochang Trade Co., Ltd. | Extract 8 | 1.00 | #4/5 |
| Mulberry extract Draco B | Extract 9 | 2.08 | ND |

Extracts 1, 3, 5, 6, 8, 9 showed the highest total polyphenol content. The result of example 3, oxidation reduction, have been indicated for comparison. The experiment shows that good oxidation inhibition was obtained with a low concentration of Morus alba extracts (0.25%) wherein the extracts have a total polyphenol level of above 0.6% GAE.

Results Total Free Amino Acid Content.

Total free amino acid content was assessed by NMR analysis. The results are indicated in the table 5 below. It was found that the extracts 1, 3, 6, and 9 showed the highest levels of total free amino acids.

TABLE 5

| | | | Oxidation |
|---|---|---|---|
| Extract name | | mg/g | reduction |
| Mulberry extract Draco A | Extract 1 | 89.31 | #2 |
| Xian Lukee Bio-Tech Co., Ltd. (Fruit) | Extract 2 | 2.65 | |
| Fengi Biotech Co., Ltd. | Extract 3 | 3.40 | #1 |
| Phyto Planet | Extract 4 | 1.49 | |
| Baoji Oasier Bio-Tech Co., Ltd. | Extract 5 | ND | #4/5 |
| Xian Lukee Bio-Tech Co., Ltd.(Leaf) | Extract 6 | 71.34 | #3 |
| Longze Biotechnology (Blackberry) | Extract 7 | ND | |
| Xian Xuochang Trade Co., Ltd. | Extract 8 | 0.95 | #4/5 |
| Mulberry extract Draco B | Extract 9 | 93.24 | ND |

Total Amount of Organic Acids

The total amount of organic acids (mg/g extract) was assessed by NMR analysis. Total amount means here citric acid, malic acid, lactic acid, formic acid, succinic acid, propionic acid, ascorbic acid and salts thereof. The level of citric acid (based on total amount of organic acid) (mg/g extract, based on dry weight of the extract) was assessed as well. The results are indicated below in table 6. The highest levels of total organic acid were found in extracts 1, 6 and 9, extracts 2, 5 and showing a lower level, and extracts 3, 4 and 7 showed the lowest levels. The result of example 3, oxidation reduction, have been indicated for comparison.

TABLE 6

| | | TOTAL | Citric acid | Oxidation |
|---|---|---|---|---|
| Extract name | | mg/g | % | reduction |
| Mulberry extract Draco A | Extract 1 | 152.92 | 66.42 | #2 |
| Xian Lukee Bio-Tech Co., Ltd. (Fruit) | Extract 2 | 20.12 | 4.38 | |
| Fengi Biotech Co., Ltd. | Extract 3 | 14.07 | 45.97 | #1 |
| Phyto Planet | Extract 4 | 5.23 | 8.84 | |
| Baoji Oasier Bio-Tech Co., Ltd. | Extract 5 | 19.64 | 59.04 | #4/5 |
| Xian Lukee Bio-Tech Co., Ltd.(Leaf) | Extract 6 | 48.45 | 23.62 | #3 |
| Longze Biotechnology (Blackberry) | Extract 7 | 13.97 | 83.76 | |
| Xian Xuochang Trade Co., Ltd. | Extract 8 | 19.51 | 64.05 | #4/5 |
| Mulberry extract Draco B | Extract 9 | 130.33 | 84.57% | ND |

Quinic Acid

The total amount of quinic acid (quinate) was assessed by NMR analysis. The results are indicated below in table 7. Quinic acid (mg/g extract, based on dry weight of the extract) was highest in extracts 1 and 9. The result of example 3, oxidation reduction, have been indicated for comparison.

TABLE 7

| | | Quinate | Oxidation |
|---|---|---|---|
| Extract name | | mg/g | reduction |
| Mulberry extract Draco A | Extract 1 | 53.36 | #2 |
| Xian Lukee Bio-Tech Co., Ltd. (Fruit) | Extract 2 | 1.37 | |
| Fengi Biotech Co., Ltd. | Extract 3 | 1.43 | #1 |
| Phyto Planet | Extract 4 | 1.24 | |
| Baoji Oasier Bio-Tech Co., Ltd. | Extract 5 | ND | #4/5 |
| Xian Lukee Bio-Tech Co., Ltd.(Leaf) | Extract 6 | ND | #3 |
| Longze Biotechnology (Blackberry) | Extract 7 | 0.82 | |
| Xian Xuochang Trade Co., Ltd. | Extract 8 | 1.11 | #4/5 |
| Mulberry extract Draco B | Extract 9 | 42.23 | ND |

Color

Method

To assess the color effect of the mulberry extracts on mayonnaise compositions, the L*a*b* values were measured of the mayonnaise compositions of Example 2, comprising 0.25 wt % extract using a Hunterlab LabScan XE colorimeter. The color was expressed as L*a*b values, wherein L* indicates the lightness (L*=0 yields black and L*=100 indicates diffuse white), a* the green/red coordinate and b* is the yellow/blue coordinate, as known in the art. The difference in color ΔE between the color of the mayonnaise with Morus alba extract and without extract is calculated as ΔE*=SQRT(ΔL*²+Δa*²+Δb*². The results are indicated in table 8. Extracts 1, 4, 5, 6 and 8 provided the smallest differences in the mayonnaise compositions.

TABLE 8

| | Extract | | | | | Oxidation |
|---|---|---|---|---|---|---|
| Mulberry extract used | number | L* | a* | b* | ΔE | reduction |
| Mulberry extract Draco A | Extract 1 | 88.54 | 4.95 | 25.33 | 2.9 | #2 |
| Xian Lukee Bio-Tech Co., Ltd. | Extract 2 | 86.44 | 9.03 | 18.07 | 10.2 | |
| (Fruit) | | | | | | |
| Fengi Biotech Co., Ltd. | Extract 3 | 37.44 | 30.42 | 3.97 | 63.7 | #1 |
| Phyto PlanetPhyto Planet | Extract 4 | 89.18 | 6.11 | 21.69 | 4.9 | |
| Baoji Oasier Bio-Tech Co., Ltd. | Extract 5 | 87.34 | 5 | 24.77 | 4.1 | #4/5 |
| Xian Lukee Bio-Tech Co., | Extract 6 | 86.56 | 4.86 | 24.81 | 4.9 | #3 |
| Ltd.(Leaf) | | | | | | |
| Longze Biotechnology | Extract 7 | 85.76 | 9.13 | 16.49 | 11.8 | |
| (Blackberry) | | | | | | |
| Xian Xuochang Trade Co., Ltd. | Extract 8 | 87.79 | 5 | 21.64 | 5.4 | #4/5 |

1. An oil-in-water emulsified food composition comprising:
Vegetable oil,
Water,
Extract of Morus alba in an amount of 0.01 to 1.5 wt %, expressed as dry weight of extract on weight of total food composition,
Acid,
wherein the extract of Morus alba comprises polyphenols in a total amount of from 0.6 to 15 GAE, %, preferably of 1 to 15 GAE %, based on the dry weight of the extract,
wherein the pH of the food composition is from 2.5 to 5.

2. The food composition according to claim 1, wherein the extract of Morus alba comprises organic acids in a total amount of from 17 to 200 mg/g, based on the dry weight of the extract.

3. The food composition according to claim 1, wherein the extract of Morus alba comprises free amino acids in a total amount of more than 3 mg/g, based on the dry weight of the extract.

4. The food composition according to claim 1, wherein the extract of Morus alba comprises citric acid and salts thereof in an amount of more than 20 wt %, based on the weight of total organic acids in the extract.

5. The food composition according to claim 1, wherein the extract of Morus alba, 0.1% dilution in water, has a color characterized by the L*a*b* values wherein the L* value is more than 80, and b* is preferably more than 1.

6. The food composition according to claim 1, wherein the vegetable oil is present in an amount of from 5 to 85 wt %.

7. The food composition according to claim 1, wherein the composition further comprises an oil-in-water emulsifier.

8. The food composition according to claim 1, wherein the food product is an emulsified sauce or a dressing.

9. The food composition according to claim 1, wherein the level of ethylenediaminetetraacetic acid is lower than 0.008% by weight, of the food composition, preferably EDTA is absent from the food composition.

10. The food composition according to claim 1, wherein the difference in color ΔE between the colour of a composition with and without the Morus alba extract, calculated as ΔE*=SQRT(ΔL*²+Δa*²+Δb*²), is of from 0 to 30.

11. A method to prepare a food product according to claim 1, the method comprising the steps of
a) adding water into a stirred vessel,
b) adding vegetable oil to the water while stirring to create a mixture;
c) combining acid and from 0.01 to 1.5 wt % (expressed as dry weight of the extract based on weight of final resulting composition) of extract of Morus alba with the water in step a), or with the mixture during step b), wherein the extract of Morus alba comprises polyphenols in a total amount of from 0.6 to 15 GAE, %, preferably of 1 to 15 GAE %, based on the dry weight of the extract,
d) homogenising the mixture resulting from step b), to create an oil-in-water emulsion.

12. The method according to claim 11, wherein in step a) egg yolk is added to the water.

13. The method according to claim 11, wherein the extract of Morus alba has a water content of less than 15 wt. %.

14. An oil-in-water emulsion comprising an extract of Morus alba in an amount of from 0.1 to 0.5 wt %, vegetable oil, water and acid, to reduce oxidation, wherein the Morus alba extract comprises total polyphenols in a total amount of from 0.6 to 15 wt %, based on the dry weight of the extract.

15. An oil-in-water emulsion according to claim 14, wherein the color of the oil-in-water emulsion has a color characterized by the L*a*b* values wherein the difference in color ΔE* between the emulsion comprising the Morus alba extract and the emulsion without the extract, calculated as ΔE*=SQRT(ΔL*²+Δa*²+Δb*²), is from 0 to 30.
